(19) United States
(12) Patent Application Publication
(10) Pub. No.: US 2012/0048237 A1
(43) Pub. Date: Mar. 1, 2012

(54) FUEL PRESSURE REGULATOR

(75) Inventor: William L. Villaire, Clarkston, MI (US)

(73) Assignee: GM GLOBAL TECHNOLOGY OPERATIONS, INC., Detroit, MI (US)

(21) Appl. No.: 12/872,404

(22) Filed: Aug. 31, 2010

(51) Int. Cl. F02M 69/54; F02M 37/04

(52) U.S. Cl. 123/457; 123/511

(57) ABSTRACT

A pressure regulator includes a housing at least partially defining a chamber. A tube defines a valve seat having an inlet disposed inside the chamber, an outlet, and a passageway extending from the inlet to the outlet. The passageway is characterized by a first portion and a second portion that is narrower than the first portion. A valve member is selectively movable between a closed position in which the valve member obstructs the inlet and an open position in which the valve member does not obstruct the inlet. A spring biases the valve member toward the closed position.

### TECHNICAL FIELD

This invention relates to pressure regulators in vehicle fuel systems.

### BACKGROUND

Vehicles typically use a fuel pump to pressurize fuel in a tank for delivery to one or more fuel injectors in an engine via a fuel line. In some vehicles, the pump maintains a constant pressure regardless of the fuel consumption of the engine. A pressure regulator is employed to return fuel from the pump or the fuel line to the tank when the pressure exceeds a predetermined amount.

### SUMMARY

A pressure regulator includes a housing at least partially defining a chamber. A tube defines a valve seat having an inlet disposed inside the chamber, an outlet, and a passageway extending from the inlet to the outlet. The passageway is characterized by a first portion and a second portion that is narrower than the first portion. A valve member is selectively movable between a closed position in which the valve member obstructs the inlet and an open position in which the valve member does not obstruct the inlet. A spring biases the valve member toward the closed position.

The second, narrower portion of the passageway adds back pressure to the regulator when fuel flows therethrough, which forces the valve member to open further, i.e., move further from the inlet, thereby reducing potential noise generated by fuel flow through the inlet. Since the tube is a separate piece from the housing, the benefit of the narrowed portion of the passageway may be added to existing regulator designs without extensive tooling or design changes.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic view of an engine system including an engine, a tank for storing fuel, a pump for transmitting fuel from the tank to the engine, and a pressure regulator for the pump; and

FIG. 2 is a schematic, cross-sectional view of the pressure regulator of FIG. 1.

### DETAILED DESCRIPTION

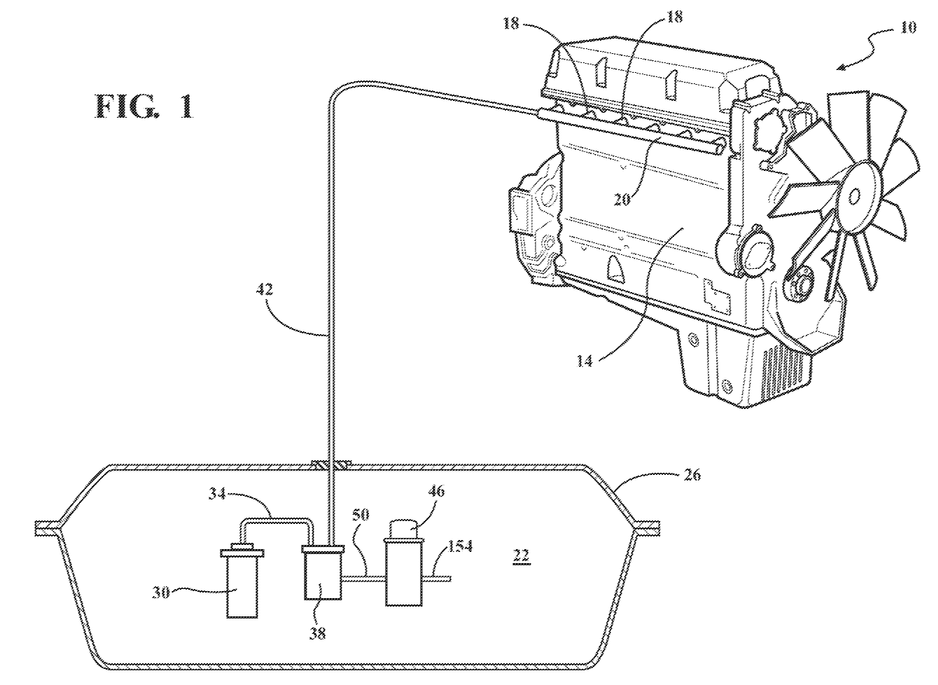

Referring to FIG. 1, an internal combustion reciprocating engine 10 includes an engine block 14, which defines a plurality of cylinders (not shown), as understood by those skilled in the art. The engine 10 also includes one or more fuel injectors 18 that are configured to inject fuel into the engine's intake system for subequent combustion inside the cylinders. The injectors 18 are operatively connected to a fuel rail 20 to receive fuel therefrom. The fuel rail 20 is in fluid communication with the chamber 22 of a fuel tank 26 to receive fuel therefrom.

More specifically, the tank 26 is configured to store fuel within the chamber 22 for use in the engine 10. A fuel pump 30 is configured to pressurize fuel from the fuel tank chamber 22 for transmission to the injectors 18. More specifically, the fuel pump 30 pressurizes fuel from the fuel tank chamber 22 and transmits the pressurized fuel via a conduit 34 to a fuel filter 38. The fuel filter 38 is in fluid communication with the injectors 18 via a fuel line 42 that interconnects the filter 38 and the injectors 18. A fuel pressure regulator 46 is operatively connected to the filter 38.

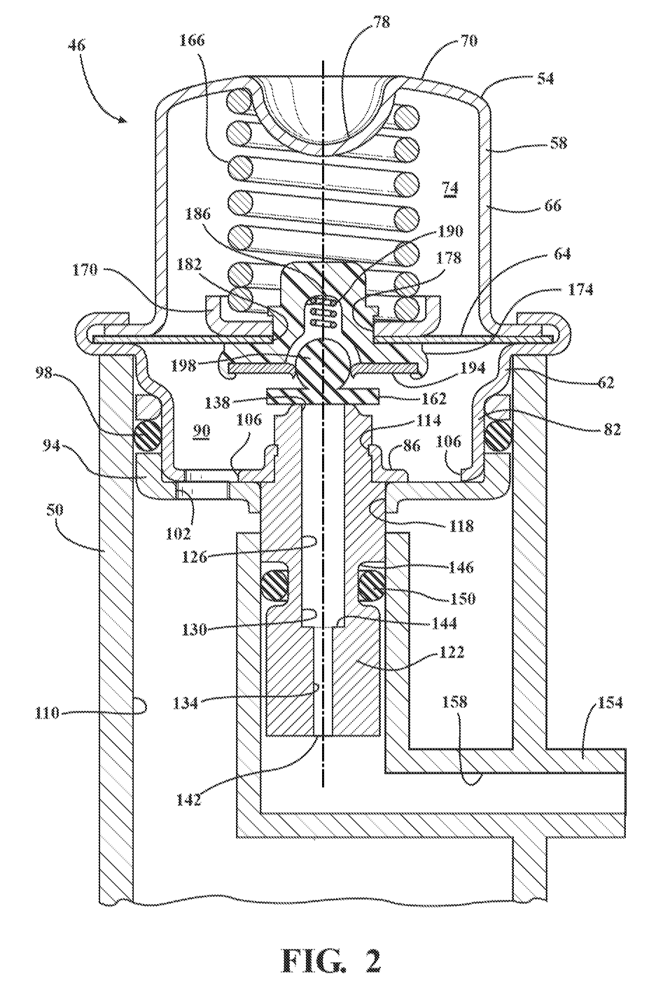

The regulator 46 is in fluid communication with the pump 30 and the fuel line 42 via the filter 38 and a conduit 50. The regulator 46 is configured to prevent the pressure in the fuel line 42 from exceeding a predetermined amount. Referring to FIG. 2, wherein like reference numbers refer to like components from FIG. 1, the regulator 46 includes a housing 54. The housing includes a first housing member 58 and a second housing member 62 that are operatively connected to each other, such as by crimping, as shown. More specifically, in the embodiment depicted, a flange of the second housing member 62 is crimped over a flange of the first housing member 58 as shown. An elastic diaphragm 64 is engaged with the crimped joint between the first and second housing members 58, 62.

The first housing member 58 includes a cylindrical wall 66 and an end wall 70. The cylindrical wall 66, the end wall 70, and the diaphragm 64 cooperate to define a generally cylindrical first chamber 74. The end wall 70 is characterized by a protuberance 78 that extends into the first chamber 74. The second housing member 62 includes a generally cylindrical wall 82 and an end wall 86. The cylindrical wall 82, the end wall 86, and the diaphragm 64 cooperate to define a generally cylindrical second chamber 90. Thus, the first and second chambers 74, 90 are separated by the diaphragm 64.

The regulator 46 in the embodiment depicted includes a base member 94 and a seal 98. The seal 98 is annular and surrounds the generally cylindrical wall 82 opposite the second chamber 90. Conduit 50 engages the seal 98 to provide fluid communication between the regulator assembly 46 and the fluid passageway 110 of the conduit 50. The base member 94 defines at least one hole 102. The end wall 86 defines a plurality of holes 106 offset from the central axis of the regulator 46. Holes 102 and 106 are sufficiently aligned such that the passageway 110 of the conduit 50 is in fluid communication with the second chamber 90 via the holes 102, 106, and thus the pump 30 and the fuel line 42 are in fluid communication with the chamber 90.

The end wall 86 also defines a hole 114 at the axis of the regulator 46, and the base member 94 defines a hole 118 that is aligned with hole 114. An outlet tube 122 extends through the holes 114, 118 such that part of the tube 122 is inside the second chamber 90 and part of the tube 122 is outside the chamber 90. The outlet tube 122 defines a passageway 126 that extends through the tube 122 from an inlet 138 to an outlet 142. The passageway 126 is characterized by a wide first portion 130 and a narrow second portion 134. The wide portion 130 extends from the inlet 138 to a lip or step 144 that extends radially inward. The narrow portion 134, which has a smaller cross-sectional diameter than the wide portion 130, extends from the lip or step 144 to the outlet 142. In the embodiment depicted, the lip or step provides an immediate transition from the wide portion to the narrow portion, i.e., there is not a tapered segment between the wide portion and the narrow portion. The tube 122 in the embodiment depicted is of one-piece construction.

The outer surface of the tube 122 defines an annular groove 146. An annular seal 150 is disposed within the groove 146. Conduit 154 defines a passageway 158 that provides fluid communication between the outlet 142 of the passageway 126 and a reservoir or the fuel tank chamber (shown at 22 in FIG. 1). The conduit 154 is engaged with the seal 150 to retain the conduit 154 with respect to the tube 122. The inlet 138 is inside the second chamber 90, and thus the tube 122 provides fluid communication between the second chamber 90 and the passageway 158 and, correspondingly, the reservoir or tank chamber 22.

A valve member 162 is disposed within the second chamber 90 and is configured to selectively obstruct the inlet 138 thereby to prevent fluid communication between the second chamber 90 and the passageways 126, 158. More specifically, when the valve member 162 is in a closed position, as shown in FIG. 2, the valve member engages the end of the tube 122, thereby obstructing fluid flow from the second chamber 90 to the passageways 126, 158. Accordingly, the portion of the tube 122 inside the chamber 90 functions as a valve seat. The valve member 162 is moveable along the axis toward the diaphragm 64 to an open position (not shown) in which the inlet 138 is unobstructed, thereby permitting fluid flow from the second chamber 90 to the passageway 126.

A spring 166 is configured to bias the valve member 162 in the closed position. More specifically, in the embodiment depicted, the spring 166 is disposed within the first chamber 74. One end of the spring 166 abuts end wall 70. The other end of the spring 166 abuts a plate 170. The plate 170 is operatively connected to a valve support member 174. More specifically, the plate 170 defines a hole 178 and the diaphraphm 64 defines a hole 182. Holes 178, 182 align along the axis of the regulator 46. The valve support member 174 extends through holes 178, 182. The valve support member 174 defines a cavity 186 in which a spring 190 is disposed. A plate 194 extends across the opening of the cavity 186 and retains the valve member 162 with respect to the valve support member 174. A spherical portion 198 of the valve member 162 extends through the plate 194 and into the cavity 186, where the spring 190 contacts the spherical portion 198.

During operation of the regulator 46, fuel from the filter 38 enters the second chamber 90 via the passageway 110 of conduit 50 and holes 102, 106. The fuel in the second chamber 90 exerts pressure on the diaphram 64. The diaphragm transfers the force of the fuel to the spring 166. That is, the diaphragm 64 is positioned and configured to transmit pressure from the second chamber 90 to the spring 166 to act against the spring bias. The spring 166 maintains the valve member 162 in the closed position until the pressure of the fuel inside the second chamber 90 is sufficiently high to overcome the bias of the spring 166, and the valve member 162 moves to the open position, thereby allowing fuel in the chamber 90 to exit through the inlet 138, passageway 126, outlet 142, and passageway 158.

The narrow portion 134 of the passageway 126 of tube 122 adds back pressure to the regulator 46, forcing the valve member 162 to open wider, thereby reducing noise generated by the fuel flow through the inlet 138. More specifically, the narrow portion 134 of the passageway 126 adds back pressure to the regulator 46, which causes the valve member 162 to move further from the inlet 138 along the axis of the regulator compared to the amount that the valve member 162 would move if the entire length of the passageway 126 had the cross-sectional area of the wide portion 130. In one embodiment, the wide portion 130 has a diameter of 3.0 millimeters, and the narrow portion 134 has a diameter of 2.2 millimeters.

While the best modes for carrying out the invention have been described in detail, those familiar with the art to which this invention relates will recognize various alternative designs and embodiments for practicing the invention within the scope of the appended claims.

1. A pressure regulator comprising:
a housing at least partially defining a chamber;
a tube defining a valve seat having an inlet disposed inside the chamber, an outlet, and a passageway extending from the inlet to the outlet;
said passageway having a first portion and a second portion that is narrower than the first portion;
a valve member being selectively movable between a closed position in which the valve member obstructs the inlet and an open position in which the valve member does not obstruct the inlet; and
a spring biasing the valve member toward the closed position.

2. The pressure regulator of claim 1, wherein the second portion of the passageway extends between the first portion and the outlet.

3. The pressure regulator of claim 2, wherein the tube is one-piece.

4. The pressure regulator of claim 1, further comprising a diaphragm that cooperates with the housing to define the chamber; wherein the diaphragm is positioned and configured to transmit pressure from the chamber to the spring to act against the spring bias.

5. The pressure regulator of claim 1, wherein the diaphragm is between the spring and the valve member.

6. An engine assembly comprising:
a fuel tank configured to store fuel;
an engine having at least one fuel injector;
a pump at least partially within the tank and configured to pressurize fuel from the tank and transmit the fuel to said at least one fuel injector;
a regulator having a housing at least partially defining a chamber that is in fluid communication with the pump; a tube defining a valve seat having an inlet disposed inside the chamber, an outlet, and a passageway extending from the inlet to the outlet; a valve member being selectively movable between a closed position in which the valve member obstructs the inlet and an open position in which the valve member does not obstruct the inlet; and a spring biasing the valve member toward the closed position;
said passageway have a first portion and a second portion that is narrower than the first portion.

7. The engine assembly of claim 6, wherein the second portion of the passageway extends between the first portion and the outlet.

8. The engine assembly of claim 7, wherein the tube is one-piece.

9. The engine assembly of claim 6, further comprising a diaphragm that cooperates with the housing to define the chamber; wherein the diaphragm is positioned and configured to transmit pressure from the chamber to the spring to act against the spring bias.

10. The engine assembly of claim 6, wherein the diaphragm is between the spring and the valve member.
